(19) United States
(12) Patent Application Publication
(10) Pub. No.: US 2020/0371823 A1
(43) Pub. Date: Nov. 26, 2020

(54) METHOD TO PERSONALIZE WORKSPACE EXPERIENCE BASED ON THE USERS AVAILABLE TIME

(71) Applicant: Citrix Systems, Inc., Fort Lauderdale, FL (US)

(72) Inventors: Anuj Magazine, Bengaluru (IN); Praveen Raja Dhanabalan, Bengaluru (IN); Sankara Narayanan, Bengaluru (IN)

(21) Appl. No.: 16/547,052

(22) Filed: Aug. 21, 2019

Related U.S. Application Data
(60) Provisional application No. 62/850,321, filed on May 20, 2019.

(51) Int. Cl. G06F 9/451; G06F 9/445; G06F 9/50

(52) U.S. Cl. CPC G06F 9/453; G06F 9/5077; G06F 9/4451

(57) ABSTRACT

Described embodiments provide systems and methods for hosted resource configuration, with intelligent personalization of a user's workspace experienced based on the user's available time. The system analyzes the user's schedule, location, and work habits, and prioritizes and maps tasks to available time slots, enabling the system to be more efficient, with less time identifying and selecting next tasks. The system may identify a period of time in which a user can perform a task associated with a hosted application; may identify at least one task associated with the hosted application, the at least one task including a duration within that of the identified period of time, and may provide, to a client device of the user, content of the hosted application based on the identified at least one task, the content enabling the user to accomplish the at least one task within the identified period of time.

### CROSS-REFERENCE TO RELATED APPLICATIONS

The present application claims the benefit of and priority to U.S. Provisional Patent Application No. 62/850,321, entitled “METHOD TO PERSONALIZE WORKSPACE EXPERIENCE BASED ON THE USERS AVAILABLE TIME,” filed May 20, 2019, the entirety of which is incorporated by reference herein.

### FIELD OF THE DISCLOSURE

The present application generally relates to computing systems and infrastructure, including but not limited to systems, products, and methods for computing workspaces.

### BACKGROUND

Hosted resources, such as remote desktops, virtual machines, web applications and software-as-a-service applications, may be accessed by users via workspace applications, and provide the user with the ability to perform many work functions, from email to data processing to video conference to programming, within a managed environment.

### SUMMARY

This Summary is provided to introduce a selection of concepts in a simplified form that are further described below in the Detailed Description. This Summary is not intended to identify key features or essential features, nor is it intended to limit the scope of the claims included herewith.

The present disclosure is directed to systems, products, and methods for hosted resource configuration, with intelligent personalization of a user's workspace experienced based on the user's available time. The system analyzes the user's schedule, location, and/or work habits, and prioritizes and maps tasks to available time slots, enabling the system to be more efficient, with less time identifying and selecting next tasks.

In one aspect, the present application is directed to a method including identifying, by a system, a period of time in which a user can perform a task associated with a hosted application. The method also includes identifying, by the system, at least one task associated with the hosted application, the at least one task including a duration within that of the identified period of time. The method also includes providing, by the system, content of the hosted application to a client device of the user based on the identified at least one task, the content enabling the user to accomplish the at least one task within the identified period of time.

In some implementations, the at least one task is identified from a plurality of tasks, each of the plurality of tasks associated with a priority; and the method includes selecting the at least one task from the plurality of tasks responsive to the at least one task having a highest priority of the plurality of tasks. In some implementations, the method includes further comprising estimating the duration of the at least one task from a history of performance of the at least one task. In some implementations, the method includes estimating the duration of the at least one task based on an amount of content associated with the at least one task and an identified rate of consumption of content. In a further implementation, the amount of content comprises an amount of text or a duration of audio or video media associated with the at least one task.

In some implementations, the method includes estimating the duration of the at least one task based on one or more actions to be performed as part of the at least one task within the hosted application. In some implementations, the method includes identifying the period of time in which the user can perform a task by identifying an average time spent by the user interacting with hosted applications from a historical log. In some implementations, the method includes identifying the period of time in which the user can perform a task by identifying a present location of the user and a travel time between the present location of the user and a location of a future scheduled event associated with the user. In some implementations, the method includes identifying the period of time in which the user can perform a task by identifying a number of tasks of the user that are identified as active.

In another aspect, the present disclosure is directed to a system, comprising a computing device comprising a processor and a network interface. In some implementations, the processor is configured to: identify a period of time in which a user can perform a task associated with a hosted application; identify at least one task associated with the hosted application, the at least one task including a duration within that of the identified period of time; and provide, via the network interface to a client device of the user, content of the hosted application based on the identified at least one task, the content enabling the user to accomplish the at least one task within the identified period of time.

In some implementations, the at least one task is identified from a plurality of tasks, each of the plurality of tasks associated with a priority; and the processor is further configured to select the at least one task from the plurality of tasks responsive to the at least one task having a highest priority of the plurality of tasks. In some implementations, the processor is further configured to estimate the duration of the at least one task from a history of performance of the at least one task. In some implementations, the processor is further configured to estimate the duration of the at least one task based on an amount of content associated with the at least one task and an identified rate of consumption of content. In a further implementation, the amount of content comprises an amount of text or a duration of audio or video media associated with the at least one task.

In some implementations, the processor is further configured to estimate the duration of the at least one task based on one or more actions to be performed as part of the at least one task within the hosted application. In some implementations, the processor is further configured to identify an average time spent by the user interacting with hosted applications from a historical log. In some implementations, the processor is further configured to identify a present location of the user and a travel time between the present location of the user and a location of a future scheduled event associated with the user. In some implementations, the processor is further configured to identify a number of tasks of the user that are identified as active.

In another aspect, the present disclosure is directed to a non-transitory computer readable medium including encoded instructions that, when executed by a processor of a computing device, cause the computing device to: identify a period of time in which a user can perform a task associated with a hosted application; identify at least one task associated with the hosted application, the at least one task including a duration within that of the identified period of time; and provide, to a client device of the user, content of the hosted application based on the identified at least one task, the content enabling the user to accomplish the at least one task within the identified period of time.

In some implementations, the computer readable medium further includes instructions that, when executed by the processor, cause the computing device to select the at least one task from a plurality of tasks, each of the plurality of tasks associated with a priority, responsive to the at least one task having a highest priority of the plurality of tasks.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of a network computing system, in accordance with an illustrative embodiment;

FIG. 1B is a block diagram of a network computing system for delivering a computing environment from a server to a client via an appliance, in accordance with an illustrative embodiment;

FIG. 1C is a block diagram of a computing device, in accordance with an illustrative embodiment;

FIG. 2 is a block diagram of an appliance for processing communications between a client and a server, in accordance with an illustrative embodiment;

FIG. 3 is a block diagram of a virtualization environment, in accordance with an illustrative embodiment;

FIG. 4 is a schematic block diagram of a cloud computing environment in which various aspects of the disclosure may be implemented ;

FIG. 5A is a flow diagram of an implementation of a method for delivery of content within a workspace based on an availability of a user;

FIG. 5B is block diagram of an implementation of a system for delivery of content within a workspace based on an availability of a user;

FIG. 5C is a flow diagram of another implementation of a method for delivery of content within a workspace based on user availability; and

FIG. 5D is a flow diagram of another implementation of a method for delivery of content within a workspace based on user availability.

### DETAILED DESCRIPTION

For purposes of reading the description of the various embodiments below, the following descriptions of the sections of the specification and their respective contents may be helpful:

Section A describes a network environment and computing environment which may be useful for practicing embodiments described herein;

Section B describes embodiments of systems and methods for delivering a computing environment to a remote user;

Section C describes embodiments of systems and methods for virtualizing an application delivery controller; and

Section D describes embodiments of systems and methods for delivery of content within a workspace based on user availability.

### A. Network and Computing Environment

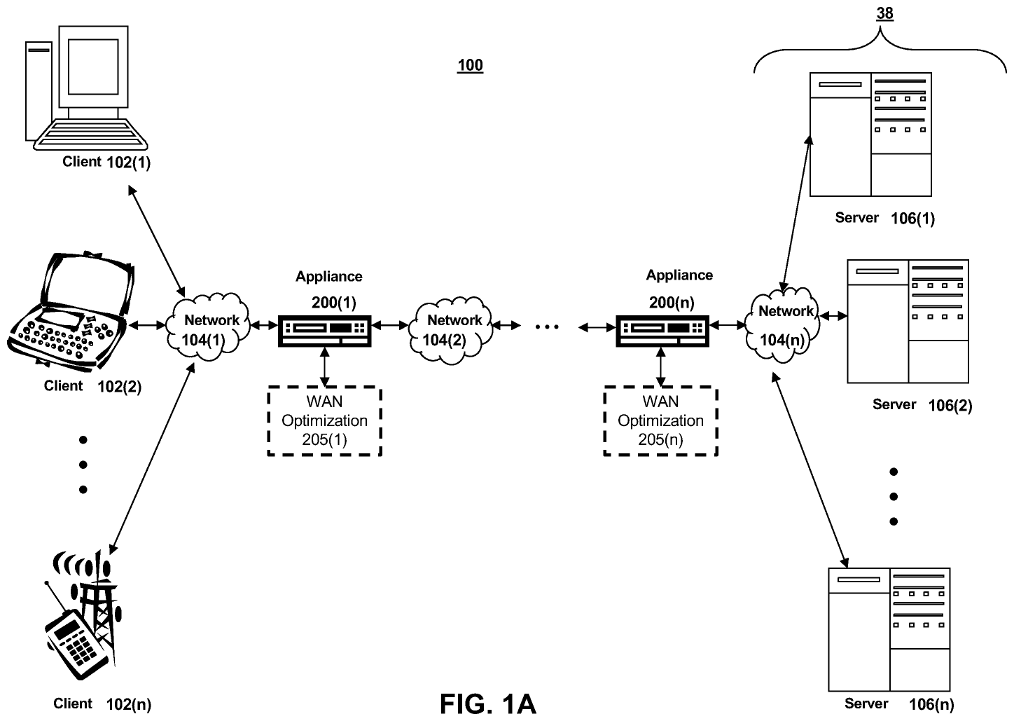

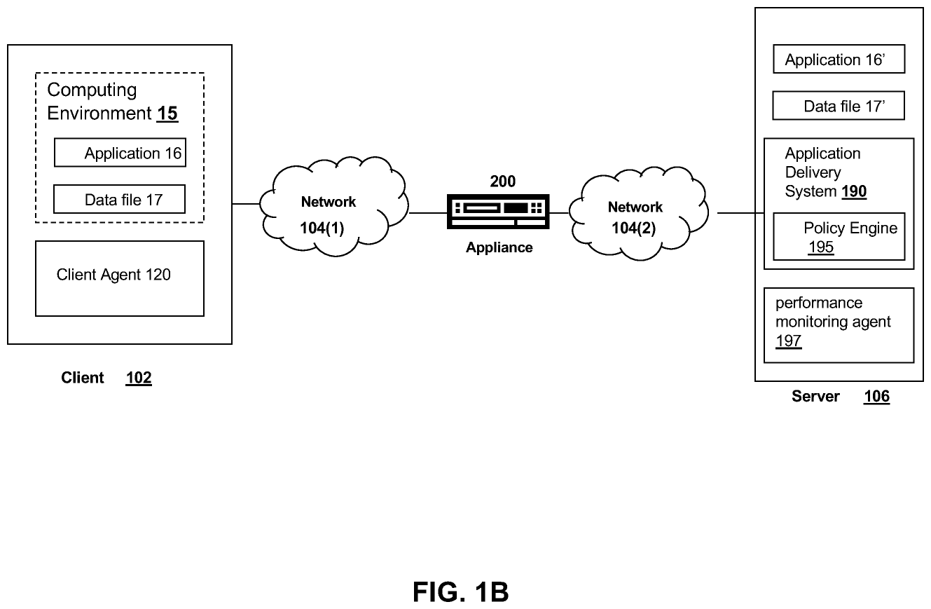

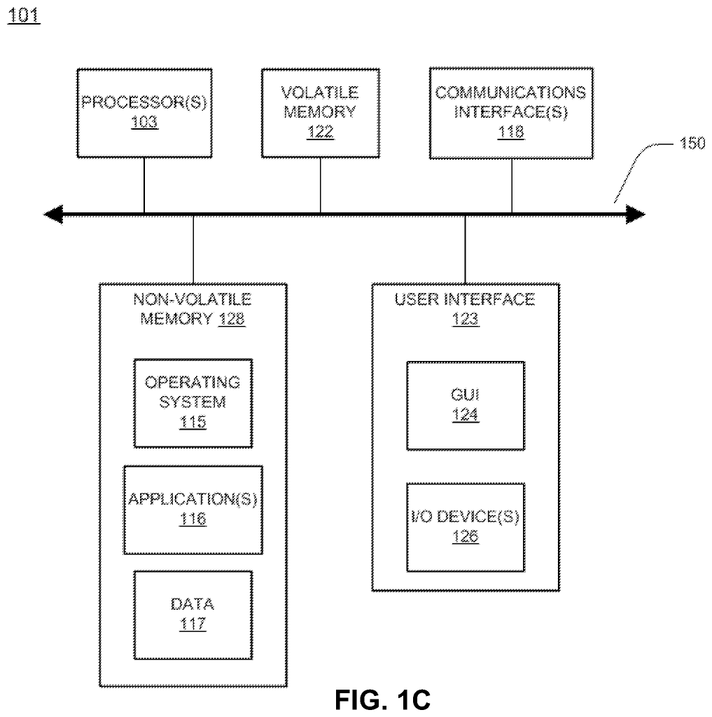

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device such as Citrix networking (formerly NetScaler®) products sold by Citrix Systems, Inc. of Fort Lauderdale, Fla.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as Citrix SD-WAN products sold by Citrix Systems, Inc. of Fort Lauderdale, Fla.

Referring to FIG. 1B, an example network environment, 100′, for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application, 16, that accesses, processes or uses a data file 17. Computing environment 15, application 16 and/or data file 17 may be delivered via appliance 200 and/or the server 106.

Appliance 200 may accelerate delivery of all or a portion of computing environment 15 to a client 102, for example by the application delivery system 190. For example, appliance 200 may accelerate delivery of a streaming application and data file processable by the application from a data center to a remote user location by accelerating transport layer traffic between a client 102 and a server 106. Such acceleration may be provided by one or more techniques, such as: 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment 15 to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example via an application stream to operate in computing environment 15 on client 102, or via a remote-display protocol or otherwise via remote-based or server-based computing. In an embodiment, application delivery system 190 may be implemented as any portion of the Citrix Workspace Suite™ by Citrix Systems, Inc., such as Citrix Virtual Apps and Desktops (formerly XenApp® and XenDesktop®).

Policy engine 195 may control and manage the access to, and execution and delivery of, applications. For example, policy engine 195 may determine the one or more applications a user or client 102 may access and/or how the application should be delivered to the user or client 102, such as a server-based computing, streaming or delivering the application locally to the client 120 for local execution.

For example, in operation, a client 102 may request execution of an application (e.g., application 16′) and application delivery system 190 of server 106 determines how to execute application 16′, for example based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc. of Fort Lauderdale, Fla. The application may be any application related to real-time data communications, such as applications for streaming graphics, streaming video and/or audio or other data, delivery of remote desktops or workspaces or hosted services or applications, for example infrastructure as a service (IaaS), desktop as a service (DaaS), workspace as a service (WaaS), software as a service (SaaS) or platform as a service (PaaS).

One or more of servers 106 may include a performance monitoring service or agent 197. In some embodiments, a dedicated one or more servers 106 may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on clients 102 (e.g., client agent 120), servers 106 (e.g., agent 197) or an appliance 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as Citrix Analytics or Citrix Application Delivery Management by Citrix Systems, Inc. of Fort Lauderdale, Fla.

The monitoring agents 120 and 197 may monitor, measure, collect, and/or analyze data on a predetermined frequency, based upon an occurrence of given event(s), or in real time during operation of network environment 100. The monitoring agents may monitor resource consumption and/or performance of hardware, software, and/or communications resources of clients 102, networks 104, appliances 200 and/or 205, and/or servers 106. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, for example periodically or in real-time, to optimize application delivery by servers 106 to clients 102 based upon network environment performance and conditions.

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer 101 shown in FIG. 1C.

As shown in FIG. 1C, computer 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of: one or more applications, one or more desktop applications, and one or more desktop sessions in which one or more applications may execute.

### B. Appliance Architecture

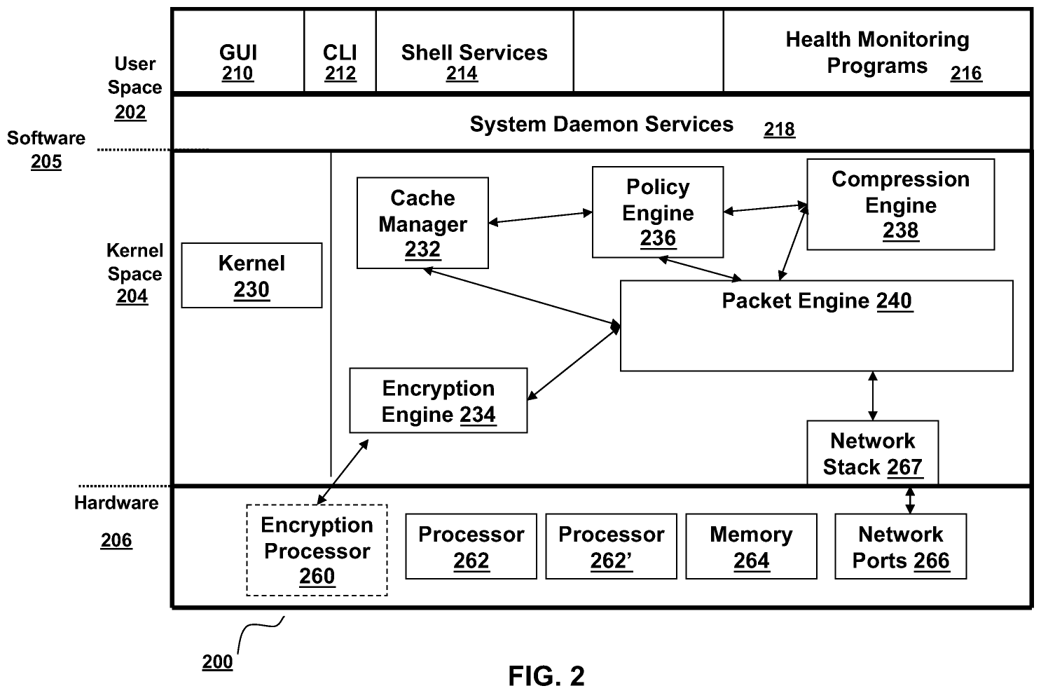

FIG. 2 shows an example embodiment of appliance 200. As described herein, appliance 200 may be implemented as a server, gateway, router, switch, bridge or other type of computing or network device. As shown in FIG. 2, an embodiment of appliance 200 may include a hardware layer 206 and a software layer 205 divided into a user space 202 and a kernel space 204. Hardware layer 206 provides the hardware elements upon which programs and services within kernel space 204 and user space 202 are executed and allow programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and encryption processor 260 for encrypting and decrypting data such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of application 104. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer 243 for queuing one or more network packets for transmission by appliance 200.

Kernel space 204 may include cache manager 232, packet engine 240, encryption engine 234, policy engine 236 and compression engine 238. In other words, one or more of processes 232, 240, 234, 236 and 238 run in the core address space of the operating system of appliance 200, which may reduce the number of data transactions to and from the memory and/or context switches between kernel mode and user mode, for example since data obtained in kernel mode may not need to be passed or copied to a user process, thread or user level data structure.

Cache manager 232 may duplicate original data stored elsewhere or data previously computed, generated or transmitted to reducing the access time of the data. In some embodiments, the cache memory may be a data object in memory 264 of appliance 200, or may be a physical memory having a faster access time than memory 264.

Policy engine 236 may include a statistical engine or other configuration mechanism to allow a user to identify, specify, define or configure a caching policy and access, control and management of objects, data or content being cached by appliance 200, and define or configure security, network traffic, network access, compression or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS or other secure connections, for example between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236 and compression engine 238, for example to perform encryption/decryption, traffic management such as request-level content switching and request-level cache redirection, and compression and decompression of data.

User space 202 is a memory area or portion of the operating system used by user mode applications or programs otherwise running in user mode. A user mode application may not access kernel space 204 directly and uses service calls in order to access kernel services. User space 202 may include graphical user interface (GUI) 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include the programs, services, tasks, processes or executable instructions to support interaction with appliance 200 by a user via the GUI 210 and/or CLI 212.

Health monitor 216 monitors, checks, reports and ensures that network systems are functioning properly and that users are receiving requested content over a network, for example by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or health of any portion of the appliance 200. Further, health monitor 216 may determine if a program, process, service or task is active and currently running, check status, error or history logs provided by any program, process, service or task to determine any condition, status or error with any portion of appliance 200. Additionally, health monitor 216 may measure and monitor the performance of any application, program, process, service, task or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layer connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may have installed and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed or controlled by client agent 120, for example to intercept and redirect a transport layer connection to an IP address and port controlled or managed by client agent 120. Thus, client agent 120 may transparently intercept any protocol layer below the transport layer, such as the network layer, and any protocol layer above the transport layer, such as the session, presentation or application layers. Client agent 120 can interface with the transport layer to secure, optimize, accelerate, route or load-balance any communications provided via any protocol carried by the transport layer.

In some embodiments, client agent 120 is implemented as an Independent Computing Architecture (ICA) client developed by Citrix Systems, Inc. of Fort Lauderdale, Fla. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication and authorization control of the client's connection to network 104. For example, client agent 120 may identify and determine one or more client-side attributes, such as: the operating system and/or a version of an operating system, a service pack of the operating system, a running service, a running process, a file, presence or versions of various applications of the client, such as antivirus, firewall, security, and/or other software.

### C. Systems and Methods for Providing Virtualized Application Delivery Controller

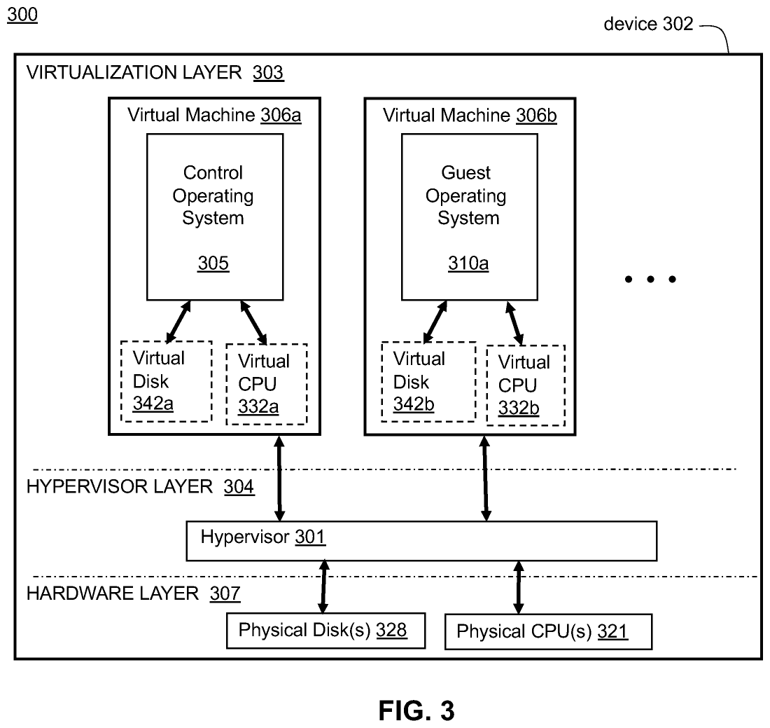

Referring now to FIG. 3, a block diagram of a virtualized environment 300 is shown. As shown, a computing device 302 in virtualized environment 300 includes a virtualization layer 303, a hypervisor layer 304, and a hardware layer 307. Hypervisor layer 304 includes one or more hypervisors (or virtualization managers) 301 that allocates and manages access to a number of physical resources in hardware layer 307 (e.g., physical processor(s) 321 and physical disk(s) 328) by at least one virtual machine (VM) (e.g., one of VMs 306) executing in virtualization layer 303. Each VM 306 may include allocated virtual resources such as virtual processors 332 and/or virtual disks 342, as well as virtual resources such as virtual memory and virtual network interfaces. In some embodiments, at least one of VMs 306 may include a control operating system (e.g., 305) in communication with hypervisor 301 and used to execute applications for managing and configuring other VMs (e.g., guest operating systems 310) on device 302.

In general, hypervisor(s) 301 may provide virtual resources to an operating system of VMs 306 in any manner that simulates the operating system having access to a physical device. Thus, hypervisor(s) 301 may be used to emulate virtual hardware, partition physical hardware, virtualize physical hardware, and execute virtual machines that provide access to computing environments. In an illustrative embodiment, hypervisor(s) 301 may be implemented as a Citrix Hypervisor by Citrix Systems, Inc. of Fort Lauderdale, Fla. In an illustrative embodiment, device 302 executing a hypervisor that creates a virtual machine platform on which guest operating systems may execute is referred to as a host server. 302

Hypervisor 301 may create one or more VMs 306 in which an operating system (e.g., control operating system 305 and/or guest operating system 310) executes. For example, the hypervisor 301 loads a virtual machine image to create VMs 306 to execute an operating system. Hypervisor 301 may present VMs 306 with an abstraction of hardware layer 307, and/or may control how physical capabilities of hardware layer 307 are presented to VMs 306. For example, hypervisor(s) 301 may manage a pool of resources distributed across multiple physical computing devices.

In some embodiments, one of VMs 306 (e.g., the VM executing control operating system 305) may manage and configure other of VMs 306, for example by managing the execution and/or termination of a VM and/or managing allocation of virtual resources to a VM. In various embodiments, VMs may communicate with hypervisor(s) 301 and/or other VMs via, for example, one or more Application Programming Interfaces (APIs), shared memory, and/or other techniques.

In general, VMs 306 may provide a user of device 302 with access to resources within virtualized computing environment 300, for example, one or more programs, applications, documents, files, desktop and/or computing environments, or other resources. In some embodiments, VMs 306 may be implemented as fully virtualized VMs that are not aware that they are virtual machines (e.g., a Hardware Virtual Machine or HVM). In other embodiments, the VM may be aware that it is a virtual machine, and/or the VM may be implemented as a paravirtualized (PV) VM.

Although shown in FIG. 3 as including a single virtualized device 302, virtualized environment 300 may include a plurality of networked devices in a system in which at least one physical host executes a virtual machine. A device on which a VM executes may be referred to as a physical host and/or a host machine. For example, appliance 200 may be additionally or alternatively implemented in a virtualized environment 300 on any computing device, such as a client 102, server 106 or appliance 200. Virtual appliances may provide functionality for availability, performance, health monitoring, caching and compression, connection multiplexing and pooling and/or security processing (e.g., firewall, VPN, encryption/decryption, etc.), similarly as described in regard to appliance 200.

In some embodiments, a server may execute multiple virtual machines 306, for example on various cores of a multi-core processing system and/or various processors of a multiple processor device. For example, although generally shown herein as “processors” (e.g., in FIGS. 1C, 2 and 3), one or more of the processors may be implemented as either single- or multi-core processors to provide a multi-threaded, parallel architecture and/or multi-core architecture. Each processor and/or core may have or use memory that is allocated or assigned for private or local use that is only accessible by that processor/core, and/or may have or use memory that is public or shared and accessible by multiple processors/cores. Such architectures may allow work, task, load or network traffic distribution across one or more processors and/or one or more cores (e.g., by functional parallelism, data parallelism, flow-based data parallelism, etc.).

Further, instead of (or in addition to) the functionality of the cores being implemented in the form of a physical processor/core, such functionality may be implemented in a virtualized environment (e.g., 300) on a client 102, server 106 or appliance 200, such that the functionality may be implemented across multiple devices, such as a cluster of computing devices, a server farm or network of computing devices, etc. The various processors/cores may interface or communicate with each other using a variety of interface techniques, such as core to core messaging, shared memory, kernel APIs, etc.

In embodiments employing multiple processors and/or multiple processor cores, described embodiments may distribute data packets among cores or processors, for example to balance the flows across the cores. For example, packet distribution may be based upon determinations of functions performed by each core, source and destination addresses, and/or whether: a load on the associated core is above a predetermined threshold; the load on the associated core is below a predetermined threshold; the load on the associated core is less than the load on the other cores; or any other metric that can be used to determine where to forward data packets based in part on the amount of load on a processor.

For example, data packets may be distributed among cores or processes using receive-side scaling (RSS) in order to process packets using multiple processors/cores in a network. RSS generally allows packet processing to be balanced across multiple processors/cores while maintaining in-order delivery of the packets. In some embodiments, RSS may use a hashing scheme to determine a core or processor for processing a packet.

The RSS may generate hashes from any type and form of input, such as a sequence of values. This sequence of values can include any portion of the network packet, such as any header, field or payload of network packet, and include any tuples of information associated with a network packet or data flow, such as addresses and ports. The hash result or any portion thereof may be used to identify a processor, core, engine, etc., for distributing a network packet, for example via a hash table, indirection table, or other mapping technique.

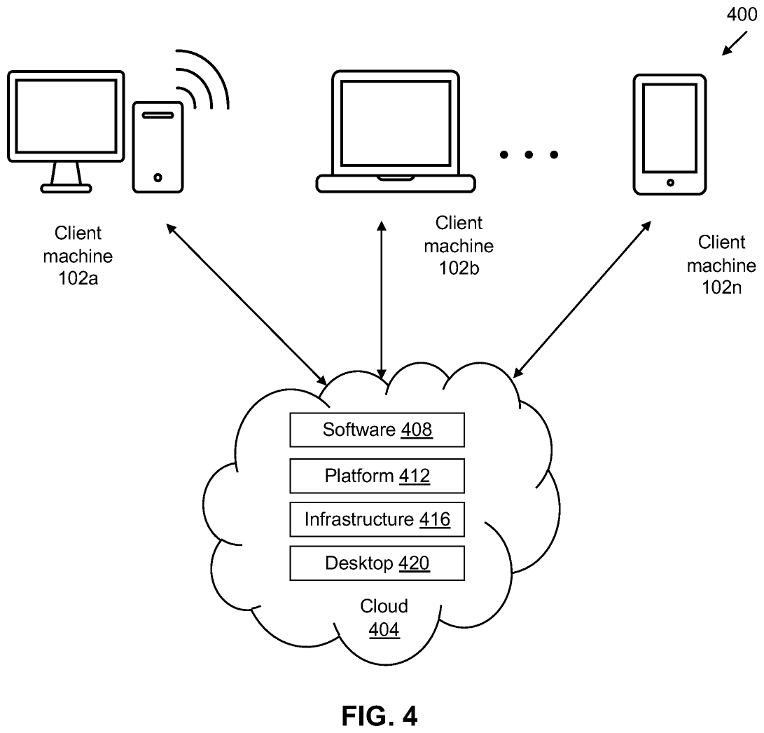

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 102a-102n (such as those described above) are in communication with a cloud network 404. The cloud network 404 may include back-end platforms, e.g., servers, storage, server farms or data centers. The users or clients 102a-102n can correspond to a single organization/tenant or multiple organizations/tenants. More particularly, in one example implementation the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and a private cloud. Public clouds may include public servers that are maintained by third parties to the clients 102a-102n or the enterprise/tenant. The servers may be located off-site in remote geographical locations or otherwise.

The cloud computing environment 400 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 102. In some embodiments, the cloud computing environment 400 can include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 408, Platform as a Service (PaaS) 412, Infrastructure as a Service (IaaS) 416, and Desktop as a Service (DaaS) 420, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

### D. Time-Based Workspace Personalization

In implementations of computing systems not utilizing the systems and methods described herein, users may waste time attempting to identify which task of a list of tasks to be performed next, or may inefficiently select a task that requires more time than available, making it necessary to resume the task at a later time. Because this takes the user “out of the flow” or interrupts their typical workflow, diverting their attention and taking time to remember and/or recover what they were working on, the resulting time spent on the task may be greater than if it was performed in a single session. For example, if a work period is contiguous, a user may spend half an hour reviewing a document and spend an hour writing a memo about the document. However, if this is divided over several time periods, the user may spend ten minutes in a first time period reviewing the document (e.g. before being interrupted with another task, completing a workday, etc.); and then rather than completing their review in twenty minutes in a second time period, may first require five minutes of re-reading to remember what was in the earlier portion of the document. If the user waits to begin writing the memo for several days, the user may first need to spend another ten minutes reviewing the document again to refresh their memory. If writing of the memo is interrupted, the user may need to review portions written earlier before beginning new portions. This may cause a task that could be completed in an hour and a half to take up two, three, or more hours.

Similarly, after completing a task or when preparing to work on a new task, many users experience a period of indecision or inefficiency in selecting a new task to work on from a large number of available tasks. Users may not immediately recognize which tasks of a number of tasks are of priority, and/or may select a task due to its perceived importance or priority, despite the task not being able to be completed within the available time. This may be a result of information overload, or a result the user being overwhelmed with the number of tasks assigned to them, the amount of information available used to select tasks (e.g. priority, categorization, deadlines, etc.). With multiple tasks and users, these inefficiencies may add up, resulting in significant amounts of wasted time and effort.

Tasks involving hosted resources, such as virtual desktop environments, remote application environments, web applications or software-as-a-service applications, or other remote resources may compound these inefficiencies, due to time required to load or access the hosted resource. For example, if a user spends an additional ten minutes indecisively determining which task to perform next, and then has to spend an additional five minutes logging in to or accessing a hosted resource before they can begin working, this results in 15 minutes of wasted time. If this occurs while switching between tasks four times per day, an hour of time has been lost.

Instead, the systems and methods described herein provide for hosted resource configuration, with intelligent personalization of a user's workspace experienced based on the user's available time. The system analyzes the user's schedule, location, and work habits, and prioritizes and maps tasks to available time slots, enabling the user to be more efficient, with less time identifying and selecting next tasks. The time required to complete tasks may be extracted from multiple applications where the user has an action item/task. This time required may be either learnt historically or directly extracted from the application. The systems and methods discussed herein allow the workspace to deliver micro apps/content/tasks personalized to the user based on his or her productive time boundaries. In some implementations, hosted resources associated with prioritized or mapped tasks may be pre-loaded or fetched, or automatically accessed prior to the user beginning work on the task (and prior to the user requesting to work on the task, or even prior to the user beginning a work period, in many implementations), significantly reducing latency or inefficiency when starting a new task or switching tasks. System utilization may also be reduced, with the elimination of time spent “idle” while a user is deciding on a new task while nonetheless consuming system resources, as well as the reduction of time spent by users reviewing or recovering work from an earlier time period that was interrupted and later resumed. For example, if a user spends an additional 10% of their time inefficiently while resuming a task (e.g. re-reading documents that have previously been read, etc.), the system may be able to reduce its resource utilization (e.g. network bandwidth, processor and memory usage, power, etc.) by 10% by eliminating this inefficiency. Accordingly, automatically mapping tasks and reducing task-switching or task-starting delays may reduce expenses and improve operations of systems with hosted resources.

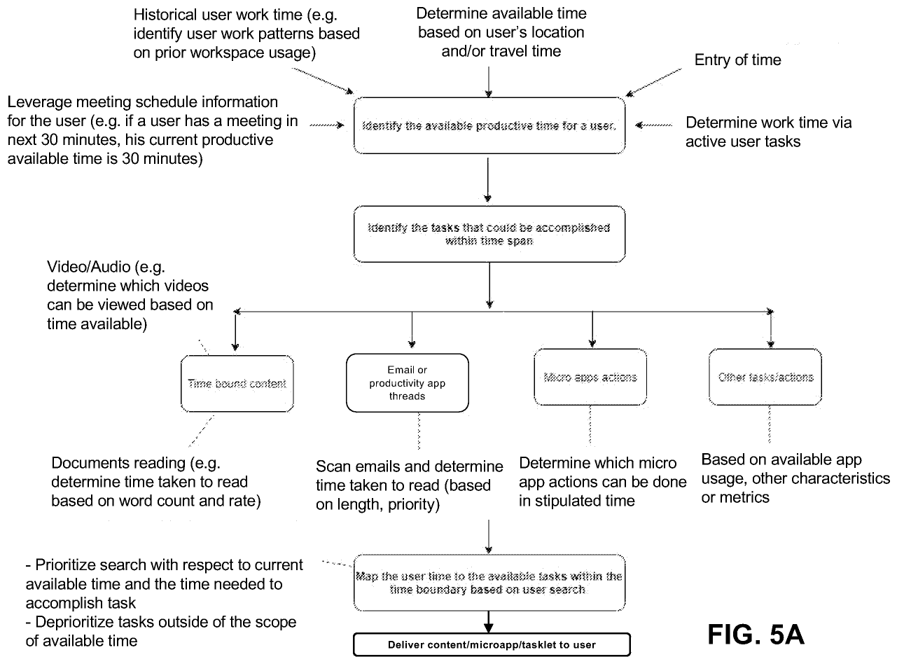

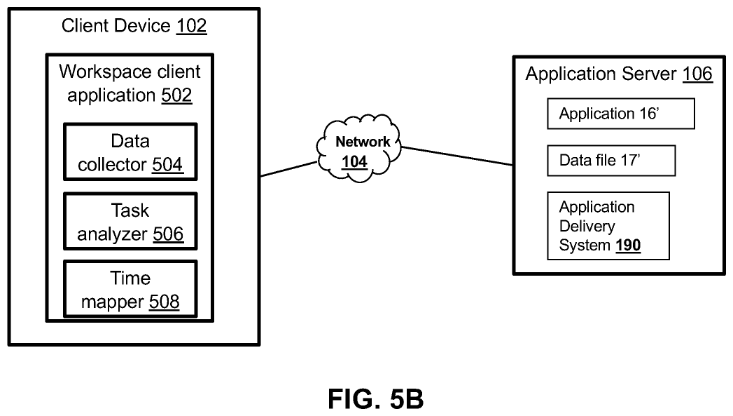

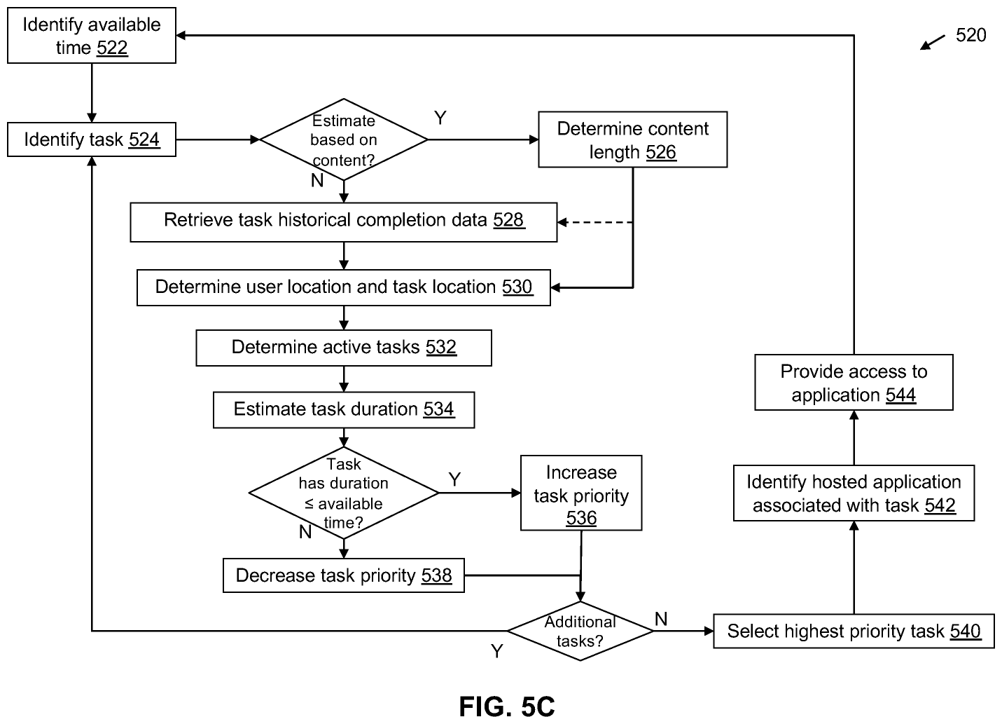

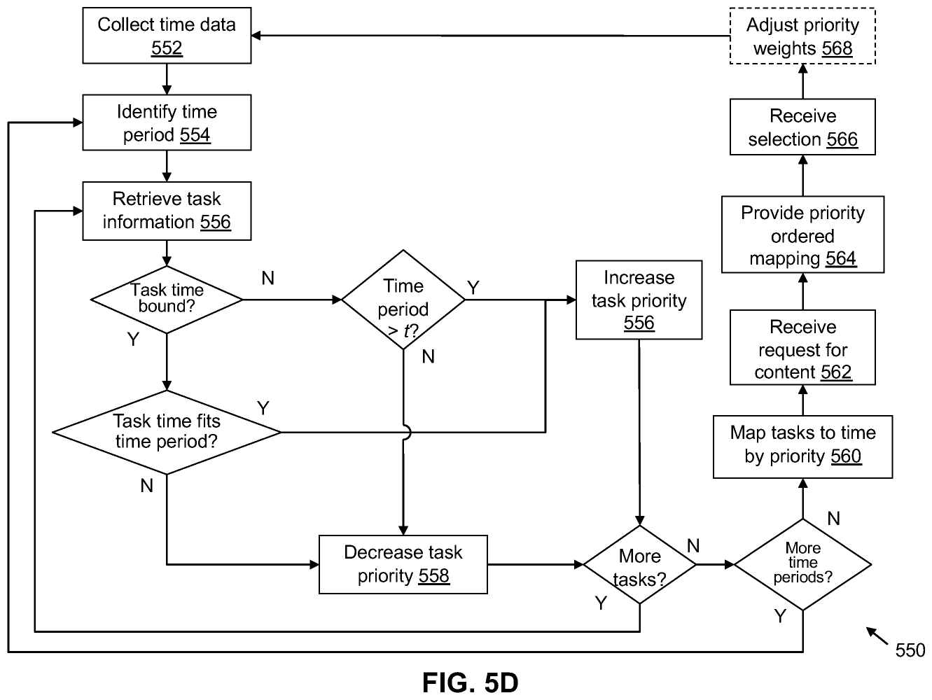

Referring first to FIG. 5A, illustrated is a flow chart of an implementation of a method for delivery of content within a workspace based on an availability of a user. The method allows identification of available productive time and delivery of content or applications to the user to complete tasks within the available time boundaries.

First, available productive time for a user may be identified based on:

User Input: Here user manually inputs his or her work time. For example, in some implementations, a user may input (e.g. via a local application interface, a form provided by a web application, a calendar application, or other such application) a work or available period start and end time. In some implementations, routine work or available periods may be input (e.g. 9 AM-5 PM, Monday-Friday), while in other implementations, specific work or available times may be input (e.g. “free for the next two hours” or “until 3 PM”). In some implementations, a user may not provide an explicit end time, but rather indicate that they are presently available (e.g. by starting a work timer or time card provided by an application or web application).

Predicted work time: This may be inferred on the historical basis of workspace app usage. Workspace apps may refer to virtualized or remote applications provided via a hosted desktop or within a virtual environment, local or remote applications connected to a host server (e.g. providing networked data storage, SaaS or PaaS services, etc.), or productivity applications utilized as part of a user's work. Such applications may be explicitly identified or classified for inclusion in calculations of predicted worktime by the user or an administrator, or may be implicitly identified based on their usage during an identified work period (e.g. a manually input work period) exceeding a threshold or occurring at a frequency above a threshold (e.g. hourly, daily, etc.). For example, time spent by the user working within an application may be tracked and averaged (e.g. if a user spends an average of an hour with a particular application, then when the user accesses the application, the system may infer that the user has approximately an hour of time to spend working), or may be tracked based on a date and time (e.g. if a user spends an hour accessing applications every Monday from 10 to 11 AM, then the system may infer that if it's Monday at 10 AM, the user likely has an hour of time available to work). Such latter implementations may be useful where a user's schedule is highly regular, even if their working time within an application varies greatly (e.g. if a user spends an hour every Monday with a particular application, but spends five hours every other weekday, then if the system allocated 4.1 hours based on the average time spent, it would overestimate time available on Mondays but underestimate time available each other day). In some implementations, the system may track an average working duration and a variance of working durations relative to the average, and use historical usage durations when the variance exceeds a threshold (e.g. more than 10% variance from the average).

Active user tasks: The amount of pending tasks left for the day that may be inferred from the apps can signal the amount of productive time for the user. For example, a large amount of remaining tasks may indicate that the user will spend extra time working. In some implementations, a task may be identified as “active” if a user has started working on the task at some point (even hours or days earlier) but has not yet completed the task. In other implementations, a task may be identified as “active” once assigned to the user until the task is complete. In still other implementations, a task may be associated with a start date or time (which may be at some point in the future relative to when the task was generated or assigned to the user), and the task may be identified as “active” once the start date or time has passed, until the task is complete. Accordingly, a task may be “active” while it is assigned, pending, not yet completed, or in any similar state or combination of these states, in contradistinction to “inactive” tasks or those that have been completed, abandoned, not yet assigned, or (in some implementations) not yet started.

Meeting schedules of the user: If a user has a meeting in the next 30 mins, his current productive available time is 30 mins. Free time windows may be determined from any available calendaring software, including web-based, cloud-based, or application-based calendars.

Work time based on User location and Travel time: If a user has a trip scheduled to a place via car, flight, bus, etc., the time prior to the trip may be identified as available time in the current location. In addition, the travel time to a destination also signals the time available before reaching a destination, which may be available for working (e.g. train, bus, plane, ridesharing service, etc.) or may be unavailable (e.g. driving, walking, etc.). This information can be inferred from APIs from ride sharing services, mapping or location services, flight reservation systems, etc.

Analytics based on email: Email may be analyzed, based on metadata (e.g. primary recipient, size of attachments, etc.) and contents (e.g. whether the email includes questions that require answers) to determine an approximate amount of time the user will spend replying to email. In some implementations, a machine learning model may be trained from the user's historical usage and email contents. For example, a regression analysis may be done based on the time the user spends responding to email and the email's contents and metadata to determine an estimated time for future emails. In some implementations, time estimated for responding to emails may be subtracted from available time. For example, if a user has an 8 hour workday, and on a typical day, spends 3 hours responding to emails, the system may determine that the user has 5 hours to work on other tasks.

Once available productive time is identified, the system may identify the tasks that could be accomplished within that available time. Tasks may be categorized into different categories, as follows:

Time bound Content: Some tasks may be associated with content, from which a duration for the task may be determined. For example, some tasks may be associated with audio or video content. The video/audio playback time may indicate the time a user needs to engage with this content. Similarly, some tasks may be associated with text content. Assuming an average reading rate of 200 words per minute (though this may be personalized to the user based on time spent previously reading content), the system may count the number of words in text content and may estimate the time the user will spend reading it.

Email: The time to read unread emails can similarly be estimated from the amount of words in the text. In addition, the system may also consider the time to read/view the attachments in the email and related conversions.

Time bound Tasks: Some certain work-related tasks are time bound, such as approving expenses through a cost center or approving leave, which typically take the same amount of time every time the task is performed. Times for these tasks may be estimated based on an average time spent performing the task previously, either from the user or aggregated across all users performing the same tasks. For some other work-related tasks, the system may determine an estimated time based on a user input. For example, the system may explicitly request an estimated time to complete a work-related task from user. This may then be used for future instances of the same task. For other work-related tasks that can't be easily measured or estimated (e.g. because they are too variable in duration), the system may estimate a maximum time and an average time.

Tasks not bound by time: Some tasks have no pattern for duration spent performing the task (e.g. if an average variance of time spent performing the task exceeds a threshold). The system may identify such tasks as not time bound. For example, a software developer may spend a very short amount of time fixing a coding error or bug in an application one day, and may spend an entire day (or longer) fixing a coding error or bug the next day, depending on complexity of the error, how involved or complex the underlying code is, etc. While an average time spent within a coding application may be calculated, the variance in time between work periods relative to the average may be very high. If the variance exceeds a threshold, rather than use an average time that may frequently be inaccurate, the system may instead identify the task as not time bound. In a similar example, a video editor rendering a scene may take a short time or long time depending on the content of the scene, its motion, the amount of filtering or processing applied to the scene, etc., resulting in rendering times ranging from seconds to hours. Using an average time of, for example, one hour, may wildly underestimate some tasks and wildly overestimate others. If the variance in historical rendering times exceeds, for example, ±20% of the calculated average time, the system may identify the task as unpredictable or not time bound.

Content not bound by time: Some content-based tasks have significant durations based on playback time or word count, such as a lengthy book, which may take a lot of time to read, well beyond the time of any particular work session. Such content may be marked that it is not time bound.

Next, the system may map the user's available productive time to the tasks/contents within the productive time boundary. For time bound content or tasks, when the user searches for available tasks in a client workspace app, the system may prioritize the search with respect to the current available productive time the user has (determined above at step 1) and the time needed to accomplish a task (determined above at step 2). The system may deprioritize the tasks that are outside the scope of available time.

For tasks or content not bound by time, the system may show the content or task to the user, if the user has available time exceeding a threshold (e.g. 30 minutes). Otherwise, the non-time bound tasks or content may be deprioritized or not be shown to the user.

In some implementations, the system may select the highest priority task or content, and may provide it to the user. In other implementations, the system may present an ordered list of tasks or content to the user, ordered based on priority as noted above, and the user may select from the list which task to perform or content to consume. The system may then provide the selected task or content to the user. Tasks or content that is time bound may be delivered to the user as a micro app or tasklet, allowing the user to focus to achieve the task.

To map tasks to times, in some implementations, an administrator may assign weights to categories for determining available productive time, such as:

User Input: 75

Predicted work time: 30

Active user tasks: 40

Meeting schedules of the user: 75

Work time based on User location and Travel time: 45

In such implementations, the system may identify the available productive time from the various methods noted above and then may apply the weights to the net time. For example, if the system identifies a predicted work time and a work time based on the user location and travel time, the net weight to identify the productive time may be 30+45 or 75.

Next, the system identifies tasks that may be accomplished within the available time windows as discussed above. If the total weight determined above is above a threshold (e.g. 50, configured by an administrator or the user), then when the user searches for content the system may show tasks identified as mapped to the current time using a 50% priority with respect to other content. Other weights may be utilized.

In another implementation, other techniques may be used to determine weights for each category. The system, for example, may initially start with equal weights (e.g. weight 50 per category). The tasks may be identified and presented to the user based on the initial weights. If the user selects a task, the weight for the corresponding category may be increased; while if the user does not select the task, the weight for the corresponding category may be decreased. This may increase the accuracy of the system over time.

FIG. 5B is block diagram of an implementation of a system for delivery of content within a workspace based on an availability of a user. A client device 102 may communicate with a server 106 via a network 104. The client device 102 may include a workspace client application 502 (e.g. in memory of the device), which may be executed by a processor of the device (not illustrated).

The workspace client application 502 may comprise an application, service, server, daemon, routine, or other executable logic for communicating with an application server 106 and providing access to an application 16′ or data file 17′ (e.g., via an application delivery system 190, as discussed above in connection with FIG. 1B). In some implementations, the workspace client application 502 may communicate with a workspace host application on an application server. Although shown on the client device, in some implementations, the workspace client application may be executed by an application server 106 and accessed via the network. For example, workspace client application may comprise a SaaS or web application accessible via a browser of the client device.

The workspace client application 502 may comprise a data collector 504, task analyzer 506, and/or a time mapper 508. Data collector 504 may comprise an application, service, server, daemon, routine, or other executable logic for identifying available time periods, such as from a schedule of the user, entered work time, active user tasks, a location service and travel schedule, or historical work time, as discussed above. Data collector 504 may monitor time accessing applications, including hosted applications, and may access calendars or other data sources via corresponding APIs. For example, data collector 504 may initiate a timer upon execution of an application or hosted application and record a timer value upon termination of the application or hosted application to determine a time spent accessing the application. In another implementation, data collector 504 may monitor a process list or task manager of the operating system of the client device or of a hosted desktop to identify executing processes, and may similarly maintain a timer to determine access durations. In a further implementation, the data collector 504 may pause such timers when the CPU utilization is below a threshold, indicating that the application may be inactive or that the user may not be interacting with the application. In a similar implementation, the data collector 504 may access other metrics to identify whether an application is being utilized, such as network activity rates associated with the application (e.g. packets transmitted or received on a corresponding port), data access rates associated with the application (e.g. memory read/write operations per second), or any other such metric. Data collector 504 may also access data sources via APIs to identify data indicating available time periods maintained by the data source, such as calendars provided by a calendar application or working periods identified in a time card or employee management application. Such APIs may allow the data collector 504 to query schedules to identify meeting start and end times, workday start and end times, or other such events.

Task analyzer 506 may comprise an application, service, server, daemon, routine, or other executable logic for identifying tasks that may be accomplished within a time span and categorizing tasks (e.g. time bound content, email, micro app actions, other tasks, etc.), as discussed above.

Time mapper 508 may comprise an application, service, server, daemon, routine, or other executable logic for mapping tasks to available productive periods, and for prioritizing and deprioritizing tasks or applying weights to task categories as discussed above. Time mapper 508 may provide a priority ordered list of tasks to select in response to a user request for a task suggestion. For example, a user may request a task through a web application or application interface provided by or associated with time mapper 508 (e.g. “what task should I work on next?”). The task mapper 508 may identify an available period or periods, create a prioritized list of tasks that may be performed within the available period or periods, and present the prioritized list of tasks to the user in response to the request. The user may select the highest priority task, or, in some implementations, may select a different task to be performed. The task may be associated with a hosted desktop, web application, or other resource, and, in some implementations, the system may instantiate or execute or otherwise allocate the application or resource to the user for performing the selected task. In some implementations, a resource associated with a highest priority task may be instantiated or allocated prior to the user selecting the task within the list, reducing loading times or access latency if the user does select the associated task. For example, a task mapper 508 may provide a list of suggested tasks with a highest priority task of “review emails”, and may launch an email application (e.g. locally or within a remote desktop or virtual desktop environment) or load an online mail application within a web browser application in the background or without rendering an output (e.g. without displaying launch or splash screens, loading screens, or any other application output). If the user selects the suggested email task, then the system may immediately begin displaying output of the application or browser application, reducing or eliminate any apparent delay for the user. In other implementations, the output of the application or web browser application may not be suppressed, or may be rendered or displayed (e.g. in a background window or separate window, in some implementations). This may help provide visual feedback to the user, particularly for applications with long loading times.

FIG. 5C is a flow diagram of another implementation of a method 520 for delivery of content within a workspace based on user availability. At step 522, a system, such as a task analyzer or computing device executing a task analyzer or workspace manager, may identify available time of a user. The available time may be determined based on a schedule of a user, such as a meeting or work schedule. For example, if a meeting is identified at a future time (e.g. one hour in the future), the available time until the meeting may be identified. In some implementations, travel time may be taken into account as part of identifying available time of the user. For example, a present location of the user or a computing device of the user may be identified (e.g. a location of a laptop computer or mobile device of the user, or the user may be identified as working locally on a computing device at a specified location, such as ‘work’ or ‘home’), and a travel time between, to, or from a meeting location may be determined. In some implementations, the travel time may be deducted from the available time to perform a task. For example, if a user's schedule indicates that they have one free hour prior to a meeting, but the meeting requires a half hour drive, the user may only have a half hour available for a task. In other implementations, the travel time may be identified as a separate potential work period for specific tasks that may be performed while traveling (e.g. on a mobile device or laptop, such as making a phone call or reviewing emails). The tasks that may be performed while traveling may be limited based on travel mode (e.g. if the user will be driving, fewer or no tasks may be available; while if the user is commuting via train, rideshare, or airplane, additional tasks may be available). Modes of travel may be specified by the user, or may be determined based on a review of email for receipts, a review of historical methods of travel used by the user between the locations or similar locations and distances, or based on aggregated historical data from multiple users (identifying that most users travel by airplane between two locations rather than driving, for example).

At step 524, a task may be selected from a list of tasks to be performed by the user. The task list may be updated by the user, a supervisor or manager, and/or generated automatically by extracting tasks from a task list of a productivity or an application (e.g., an e-mail application); parsing emails or schedule items of the user; or a combination of these or other additions. The task list may identify tasks, categories of tasks, locations of tasks, or other information, and may include estimated times to perform the tasks, times based on budget allocations for the task, or other indications of times, such as a historical average time taken to perform the task by the user and/or other users.

As discussed above, some tasks may have a length or duration based on their content. For example, it may take longer for a user to read a lengthy text than a short one, and may take longer to watch a longer video or listen to a longer audio presentation than a short one. In many such instances, at step 526 the system may estimate a duration or time to complete the task based on the length or duration of the content and a consumption rate (e.g. words per minute read, etc.). The consumption rate may be predetermined (e.g. one minute per minute of video or audio), or may be determined based on an average historical time of the user (e.g. if the user took 10 minutes to read 10 pages previously, a one page per minute rate may be determined). Consumption rates may also be aggregated from a group of users to determine an average consumption rate. This may be particularly helpful where a historical consumption rate is not available for a user. Additionally, rates may be adjusted over time or by a user. For example, some users may typically watch videos at a faster than normal playback rate, increasing their consumption rate (e.g. 1.5× or 2×, relative to the normal playback speed of the video). Accordingly, at step 526, in such implementations, the system may determine a length or duration of the content and/or a consumption rate for the content, and may estimate a time to consume the content. In some implementations in which a task has multiple parts, the length or duration of each part of the content may be identified and aggregated (e.g. when a task requires watching a video and reading several pages).

If the system cannot estimate task length based on the length or duration of the content to be consumed as part of the task (or in some implementations after estimating task length based on the length or duration of the content), then in some implementations at step 528, the system may retrieve historical completion statistics for the task or for a similar task (e.g. in a similar category) that identify a time spent by the user (or aggregated from a group of users) to complete the task. In some implementations, if a task includes multiple subtasks, completion statistics may be retrieved for each subtask and aggregated.

At step 530 in some implementations, the system may determine a user location and task location, and determine travel time between the user location and task location. As noted above, travel time may affect the available time of the user, and in some implementations, may be deducted from the time available for the user. For example, travel time may be deducted from available time when the user has a specific appointment, meeting, or other activity that requires them to be at a particular location. In other implementations, travel time may be added to the time to complete the task and may be considered part of the task time. For example, if a subsequent meeting is not scheduled such that travel time needs to be accounted into the user's available time before the meeting, the user may have a large block of available time. If a task to be fulfilled has a similar estimated time, the system may assign or suggest the task to be fulfilled within the block of available time. However, if the task is required to be performed at a different location, failure to include travel time as part of the task time may underestimate the actual time to complete the task. Accordingly, travel time for a task with a location that is not at the user's present location may be included as part of estimating the time to complete the task. Travel time may be estimated according to any appropriate method of travel, which may be identified based on distance to be traveled, the user's historical travel methods, etc., as noted above.

At step 532 in some implementations, the system may determine whether the user has other active tasks. For example, in some instances, multiple tasks may be performed in parallel or concurrently, as where tasks include idle or inactive periods (e.g. while a system is processing or rendering data, while an experiment is running, etc.). Executing multiple tasks in parallel may reduce efficiency for each task, and in some implementations, the system may increase estimates to complete each task by a scaling factor based on the number of concurrent or active tasks being performed (e.g. 1 for one task, 1.2 for two tasks, 1.5 for three tasks, or any other such values). Additionally, in some implementations, active tasks may be used to identify available time for a user at step 522. For example, the system may monitor periods in which tasks are active during a day to identify working periods. For example, if a user habitually has active tasks from 9 AM to 5 PM on weekdays, the system may identify those periods as a regular work schedule; while if the user has active tasks at 10 PM on Mondays and Tuesdays, the system may identify that the user works late on those days. The system may monitor active tasks over a period of days or weeks to identify a user's typical work schedule, and may suggest or assign additional tasks within the identified period accordingly.

At step 534, the system may estimate a duration to complete the task identified or selected at step 524. As discussed above, the estimated duration or time to complete the task may be based on the content length or duration at step 526, historical completion data at step 528, the user's location at step 530, and/or whether additional tasks are being performed in parallel, or any combination of these elements. For example, in some implementations, the estimated duration or time may be based on a weighted average of these elements and/or a sum of the elements. For example, in one such implementation, an estimated time based on content length and rate of consumption may be averaged with an estimated time based on historical completion data, with the result adjusted based on a number of active tasks.

Once the time to complete the task has been estimated, the system may determine if the task has a duration less than or equal to the identified available time. If so, then at step 536, in some implementations, the system may increase a priority or score associated with the task. If not, then at step 538, the system may decrease a priority or score associated with the task. Steps 524-538 may be repeated iteratively for each additional task, in some implementations. Tasks may have an initial or default priority in some implementations, or may have a priority set by a user or assignor of the task. This may allow for some tasks to be prioritized ahead of others, such that the system may assign them first (if sufficient time is available).

At step 540, the system may identify a highest priority task from the set of identified tasks, in some implementations. In some implementations, the suggested task may be identified to a user, and the user may confirm to initiate the task or may select a different task. In some such implementations, if the user selects a different task, the task priorities may be adjusted (e.g. with the selected task's priority being increased, and/or the suggested task's priority decreased). This may allow the system to learn user preferences for priority over time.

At step 542, the system may identify a hosted application or desktop associated with the task, and at step 544, may provide access to the identified hosted application or desktop to a computing device of the user. This may include instantiating web services or Software-as-a-service (SaaS) applications, or remote desktop software, executing a virtual machine for the user, or performing other set up procedures to allow the user to begin the selected task (e.g. loading corresponding data, etc.). For example, a system may identify a web application or SaaS application associated with a task, launch or execute a local web browser application or browser instance, and direct the web browser application or instance to request a page associated with the web application or SaaS application at a specified uniform resource locator (URL) address. In some implementations, a system may transmit a request to an application or resource server to reserve or execute a virtual machine to be used by the computing device of the user, may request a configuration file or script associated with the task for a remote desktop application, or otherwise initiate steps to provide the user with access to the applications and/or resources necessary to perform the identified task.

FIG. 5D is a flow diagram of another implementation of a method 550 for delivery of content within a workspace based on user availability. At step 552, a client device or workspace server may collect time data. The time data may be collected from one or more calendars with meetings and free periods, from location service or travel reservation services, from manually entered time data, etc., as discussed above. For example, a client device or workspace server may access data sources via APIs to identify data indicating available time periods maintained by the data source, such as calendars provided by a calendar application or working periods identified in a time card or employee management application. Such APIs may allow the client device or workspace server to query schedules to identify meeting start and end times, workday start and end times, or other such events.

At step 554, in some implementations, the client device or workspace server may identify a first time period. The time period may be a present time period, or a future time period. The client device or workspace server may identify the time period responsive to a request from a user for a task, e.g. for the present time period. The time period may be defined by a start time and end time, start time and duration, or end time and duration.

At step 556, the client device or workspace server may retrieve task information for a task from a local storage device and/or from a remote storage device, such as a server maintaining a database or list of tasks (e.g. a management server, a data server, or other such network accessible storage device). The task may be identified in a list of tasks of the user, and may be manually generated (e.g. manually entered tasks, from tasks assigned by an administrator or manager, etc.) or may be dynamically created (e.g. from tasks extracted from email or a worklist of available tasks). For example, a data collector 504 as discussed above in connection with FIG. 5B may identify tasks by parsing emails for keywords or specified phrases (e.g. “meeting at” or “call with”); retrieving tasks via an API of a task management, project management, or calendar application; by extracting XML fields identifying tasks and associated information from a data file; or any other similar methods.

As discussed above, tasks may be time bound or unbound. If a task is not time bound, then the system may determine whether sufficient time exists in the time period (e.g. if the duration of the period exceeds a threshold). If so, then the task priority may be increased at step 556. If not, at step 558, the task priority may be decreased.

Similarly, if a task is time bound, then the client device or workspace server may determine the task duration, e.g. by extracting parameters from the task, such as a length of a video or audio file, a number of words in content to be read, a time based on historical durations with the task, etc., as discussed above. For example, a data collector 504 as discussed above in connection with FIG. 5B may identify a document associated with a task (e.g. explicitly identified along with the task in a task list, attached to an email associated with the task, attached to a calendar invite for the task, referenced via a hyperlink in text of an email or calendar associated with the task, etc.), and may determine a length or duration of the document (e.g. from metadata of the document, such as a content length header; by counting a number of words or pages in the document; by determining dividing a size of the document by a bitrate of the document identified in a header to determine a length; etc.). If the identified duration fits within the time period, then the priority may be increased at step 556. If not, then at step 558, the task priority may be decreased.

The process may repeat iteratively in some implementations for a plurality of tasks. Similarly, in some implementations, the process may repeat iteratively for additional time periods (e.g. later periods during a day or week).

At step 560, the tasks may be mapped to times by priority. As discussed above, tasks may be associated with a time period if they fit within the time period, and may be listed in priority order. For example, the system may associate or map a task to a particular time period if the estimated duration of the task is less than the duration of the time period. Where multiple tasks have durations less than the time period, each task may be mapped to the same time period, and listed in order of associated priority. Similarly, if multiple time periods are available, a task may be mapped to multiple time periods. In some such implementations, the tasks may have different relative priorities or be placed in a different order in a list of tasks for each time period. For example, a task may be considered low priority during a first time period and be placed lower in a list of tasks mapped to the first time period, but be considered high priority during a second time period (for example, if the second time period is closer to a deadline for completing the task, the priority of the task may be increased for the second time period), and may be placed higher in a list of tasks for the second time period.

In another implementation, only a single task may be mapped to any given time period (although alternate tasks may be included in a list of suggested tasks). The single task mapped to the time period may be a task having a highest priority of tasks with estimated durations that are less than the time period. The system may iteratively map additional tasks to additional available time periods, with tasks mapped to earlier time periods excluded from being mapped to subsequent time periods. This may allow the system to generate a day, week, month, or longer suggested schedule or task list based on an assumption that each suggested task is completed during the corresponding time period. The system may recalculate or regenerate the schedule as necessary, dynamically updating the entire schedule or list as items are completed and/or tasks are not completed during a corresponding time period (e.g. causing the system to reallocate or map the task to a subsequent time period).

At step 562, in some implementations, the user may search for or request a task to be done or content to be consumed, for example, via an application or web interface (e.g. selecting a “suggest a new task to complete” button or similar interface element). The request may comprise an HTTP POST or GET request or similar representational state transfer (RESTful) request, a remote procedure call to a remote application, a function of an API of a task management system, or other such formats, and may be provided by the application or web interface to a workspace client application or task management application on the user's computing device or at a remote application or management server, as discussed above in connection with FIG. 5B. Responsive to the request, at step 564, the client device or workspace server may provide the priority ordered mapping of tasks to the user for selection. The mapping may be provided for a time period (e.g. a current time period), with a priority ordered set of tasks, e.g. as generated at step 560 discussed above. At step 566, the user may select a task, and the client device or workspace server may provide access to the task or content (e.g. by instantiating a virtual machine or hosted desktop, by providing a web application, by launching a local application, by instantiating a secure virtual browser, etc.). In some implementations, the user may manually select a task (e.g. from a list of one or more suggested tasks, ordered by priority as discussed above). The task list may be shown via a user interface of an application or browser instance (e.g. for a web application or service providing the task management system), and the user may select an interface element corresponding to the task (e.g. an item in a menu of items corresponding to each task of the one or more tasks mapped to the time period). In other implementations, the highest priority task may be automatically selected for the user. In some such implementations, the task selection may be verified by the user. For example, the system may select a highest priority task, such as “review email”, and present a user interface element suggesting the corresponding task and confirming that the user wishes to begin (e.g. a dialog box confirming whether the user wants to start reviewing email). If the user declines to start the suggested task, in some implementations, a next highest priority task may be selected and suggested to the user. This may be repeated iteratively until the user confirms to begin working on a task, or has declined all suggested tasks, in some implementations.

As discussed above, in some implementations, the user may not select the highest priority task. Accordingly, optionally or in some implementations, to increase accuracy of future prioritization, at step 568, the client device or workspace server may adjust priority weights for task categories or types, as discussed above. Over time, the system may thus become more accurate at planning out tasks according to the user's preferences.

Thus, the systems and methods described herein provide for hosted resource configuration, with intelligent personalization of a user's workspace experienced based on the user's available time. The system analyzes the user's schedule, location, and work habits, and prioritizes and maps tasks to available time slots, enabling the system to be more efficient, with less time identifying and selecting next tasks.

In some aspects, the present disclosure describes a method for dynamic workspace configuration. The method includes receiving, by workspace configuration system, a user schedule. The method also includes identifying, by the workspace configuration system from the user schedule, a period of available time. The method also includes selecting, by the workspace configuration system, a first task from a plurality of tasks. The method also includes identifying, by the workspace configuration system, a hosted application corresponding to the first task; and providing, by the workspace configuration system to a computing device of the user, the identified hosted application.

In some implementations, each of the plurality of tasks is associated with a priority, and the method includes selecting the first task responsive to the first task having a highest priority of the plurality of tasks. In a further implementation, the period of available time has a first duration, and the method includes increasing the priority associated with the first task responsive to a duration associated with the first task being less than the first duration. In a still further implementation, the method includes estimating the duration associated with the first task from a history of performance of the first task. In another further implementation, the period of available time has a first duration, and the method includes increasing the priority associated with the first task responsive to the first duration being above a predetermined threshold. In a still further implementation, the method includes increasing the priority associated with the first task responsive to a variability of durations from a history of performance of the first task being above a second threshold. In yet another further implementation, the period of available time has a first duration, and the method includes decreasing the priority associated with a second task of the plurality of tasks, responsive to a duration associated with the second task being greater than the first duration. In a still further implementation, the method includes estimating the duration associated with the second task from a history of performance of the second task. In another further implementation, the period of available time has a first duration, and the method includes decreasing the priority associated with a second task of the plurality of tasks, responsive to the first duration being less than a predetermined threshold.

In some implementations, each of the plurality of tasks is associated with a priority, and selecting the first task from the plurality of tasks includes: providing a priority ordered mapping of tasks to the computing device of user; receiving, from the computing device of the user, a selection of the first task, the first task having a lower priority than at least one other task of the plurality of tasks; and increasing the priority associated with the first task, responsive to receipt of the selection of the first task.

In another aspect, the present disclosure is directed to a system for dynamic workspace configuration. The system includes a computing device comprising a processor and a network interface, the processor executing a workspace configuration system configured to: receive, via the network interface, a user schedule; identify, from the user schedule, a period of available time; select a first task from a plurality of tasks; identify a hosted application corresponding to the first task; and provide, via the network interface to a computing device of the user, the identified hosted application.

In some implementations, each of the plurality of tasks is associated with a priority, and the workspace configuration system is further configured to select the first task responsive to the first task having a highest priority of the plurality of tasks. In a further implementation, the period of available time has a first duration, and the workspace configuration system is further configured to increase the priority associated with the first task responsive to a duration associated with the first task being less than the first duration. In a still further implementation, the workspace configuration system is further configured to estimate the duration associated with the first task from a history of performance of the first task. In another further implementation, the period of available time has a first duration, and the workspace configuration system is further configured to increase the priority associated with the first task responsive to the first duration being above a predetermined threshold. In a still further implementation, the workspace configuration system is further configured to increase the priority associated with the first task responsive to a variability of durations from a history of performance of the first task being above a second threshold. In another further implementation, the period of available time has a first duration, and the workspace configuration system is further configured to decrease the priority associated with a second task of the plurality of tasks, responsive to a duration associated with the second task being greater than the first duration. In a still further implementation, the workspace configuration system is further configured to estimate the duration associated with the second task from a history of performance of the second task. In another further implementation, the period of available time has a first duration, and the workspace configuration system is further configured to decrease the priority associated with a second task of the plurality of tasks, responsive to the first duration being less than a predetermined threshold. In another implementation, each of the plurality of tasks is associated with a priority, and the workspace configuration system is further configured to: provide a priority ordered mapping of tasks to the computing device of user; receive, from the computing device of the user, a selection of the first task, the first task having a lower priority than at least one other task of the plurality of tasks; and increase the priority associated with the first task, responsive to receipt of the selection of the first task.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

What is claimed:

1. A method comprising:
identifying, by a system, a period of time in which a user can perform a task associated with a hosted application;
identifying, by the system, at least one task associated with the hosted application, the at least one task including a duration within that of the identified period of time; and
providing, by the system, content of the hosted application to a client device of the user based on the identified at least one task, the content enabling the user to accomplish the at least one task within the identified period of time.

2. The method of claim 1, wherein the at least one task is identified from a plurality of tasks, at least one of the plurality of tasks being associated with a priority; and further comprising:
selecting the at least one task from the plurality of tasks responsive to the at least one task having a highest priority of the plurality of tasks.

3. The method of claim 1, further comprising estimating the duration of the at least one task from a history of performance of the at least one task.

4. The method of claim 1, further comprising estimating the duration of the at least one task based on an amount of content associated with the at least one task and an identified rate of consumption of content.

5. The method of claim 4, wherein the amount of content comprises text or audio or video media associated with the at least one task.

6. The method of claim 1, further comprising estimating the duration of the at least one task based on one or more actions to be performed as part of the at least one task within the hosted application.

7. The method of claim 1, wherein identifying the period of time in which the user can perform a task further comprises identifying an average time spent by the user interacting with hosted applications from a historical log.

8. The method of claim 1, wherein identifying the period of time in which the user can perform a task further comprises identifying a location of the user and a travel time between the location of the user and another location.

9. The method of claim 1, wherein identifying the period of time in which the user can perform a task further comprises identifying a number of tasks of the user that are identified as active.

10. A system, comprising:
a computing device comprising a processor and a network interface, the processor configured to:
identify a period of time in which a user can perform a task associated with a hosted application,
identify at least one task associated with the hosted application, the at least one task including a duration within that of the identified period of time, and
provide, via the network interface to a client device of the user, content of the hosted application based on the identified at least one task, the content enabling the user to accomplish the at least one task within the identified period of time.

11. The system of claim 10, wherein the at least one task is identified from a plurality of tasks, at least one of of the plurality of tasks being associated with a priority; and wherein the processor is further configured to select the at least one task from the plurality of tasks responsive to the at least one task having a highest priority of the plurality of tasks.

12. The system of claim 10, wherein the processor is further configured to estimate the duration of the at least one task from a history of performance of the at least one task.

13. The system of claim 10, wherein the processor is further configured to estimate the duration of the at least one task based on an amount of content associated with the at least one task and an identified rate of consumption of content.

14. The system of claim 13, wherein the amount of content comprises text or audio or video media associated with the at least one task.

15. The system of claim 10, wherein the processor is further configured to estimate the duration of the at least one task based on one or more actions to be performed as part of the at least one task within the hosted application.

16. The system of claim 10, wherein the processor is further configured to identify an average time spent by the user interacting with hosted applications from a historical log.

17. The system of claim 10, wherein the processor is further configured to identify a location of the user and a travel time between the location of the user and another location.

18. The system of claim 10, wherein the processor is further configured to identify a number of tasks of the user that are identified as active.

19. A non-transitory computer readable medium including encoded instructions that, when executed by a processor of a computing device, cause the computing device to:
identify a period of time in which a user can perform a task associated with a hosted application,
identify at least one task associated with the hosted application, the at least one task including a duration within that of the identified period of time, and
provide, to a client device of the user, content of the hosted application based on the identified at least one task, the content enabling the user to accomplish the at least one task within the identified period of time.

20. The computer readable medium of claim 19, further comprising instructions that, when executed by the processor, cause the computing device to select the at least one task from a plurality of tasks, each of the plurality of tasks associated with a priority, responsive to the at least one task having a highest priority of the plurality of tasks.
